(19) United States
(12) Patent Application Publication
(10) Pub. No.: US 2008/0195793 A1
(43) Pub. Date: Aug. 14, 2008

(54) MICROCONTROLLER WITH MEMORY TRACE MODULE

(75) Inventors: Frank Noha, Sugar Land, TX (US); Bernhard Fuessl, Moosburg / Aich (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND GMBH

(21) Appl. No.: 12/027,013

(22) Filed: Feb. 6, 2008

(30) Foreign Application Priority Data
Feb. 9, 2007 (DE) 102007006508.8

(51) Int. Cl. G06F 13/20

(52) U.S. Cl. 710/313

(57) ABSTRACT

The present invention relates to a microcontroller comprising a central processing unit, a memory, a bus coupling the memory to the central processing unit, and a memory trace module for tracing at least one of a data of a write access to memory or data of a read access from the memory. The memory trace module comprises a first interface being coupled to the bus for capturing at least one of the data or corresponding address information on the bus, and a second interface being adapted to be coupled to an external device, wherein the memory trace module is adapted to transfer data from the first to the second interface and from the second interface to the external device.

### CROSS-REFERENCE TO RELATED APPLICATIONS

The present invention claims benefit of German patent application filing number 10 2007 006 508.8, filed on Feb. 9, 2007, which is herein incorporated by reference.

### BACKGROUND OF THE INVENTION

1. Field of the Invention

The present invention relates to a microcontroller including a central processing unit and a memory coupled to a bus.

2. Description of the Related Art

For the development of microcontroller-based applications where the microcontroller has internal memory (e.g. RAM) and interfaces to peripheral devices, it is usually necessary to monitor the data traffic between a bus master, as e.g. the central processing unit (CPU), and internal memories or interfaces to peripherals. Up to date microcontroller platforms use software solutions or direct memory access (DMA) to communicate internal data to an external device for data logging, data inspection and debugging. However, the conventional approach requires suspending the regular data processing to transmit the data to the external device and to resume normal operation when the extra data transmission is completed. If DMA is used to transfer data to an external device, the Central Processing Unit (CPU) may continue normal operation, but access to the same memory resource by the CPU is impossible during DMA.

Therefore, it is an object of the present invention to provide a microcontroller with improved transparency of internal data transfers and less interference with target operation during application development.

### SUMMARY OF THE INVENTION

Embodiments of the present invention generally relate to microcontroller and a method for transmitting data. The microcontroller comprises a central processing unit, a memory, a bus coupling the memory to the central processing unit, and a memory trace module for tracing at least one of a data of a write access to memory or data of a read access from the memory. The memory trace module comprises a first interface being coupled to the bus for capturing at least one of the data and corresponding address information on the bus, and a second interface being adapted to be coupled to an external device, wherein the memory trace module is adapted to transfer data from the first to the second interface and from the second interface to the external device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram of a microcontroller according to an embodiment of the present invention;

FIG. 2 is a simplified block diagram of a memory trace module according to an embodiment of the present invention;

FIG. 3 shows different packet structures according to an aspect of the present invention;

FIG. 4 shows signal waveforms and timing according to an aspect of the present invention; and

FIG. 5 shows further signal waveforms according to aspects of the present invention.

### DETAILED DESCRIPTION

In one embodiment, a microcontroller is presented including a central processing unit, a memory, a bus coupling the memory to a bus master, as for example the CPU, and a memory trace module for tracing data of a write access to and/or a read access from the memory. The memory trace module may include a first interface being coupled to the bus for capturing the data and a corresponding address information on the bus and a second interface being adapted to be coupled to an external device, wherein the memory trace module is adapted to transfer, in a trace mode, the captured data and address information from the first to the second interface and from the second interface to an external device. A microcontroller having a memory trace module according to the present invention is capable of capturing data directly from the bus connecting the memory or a plurality of memories to any bus master device as for example the CPU or DMA. The memory trace module is further adapted to capture the data and the corresponding address information substantially in the form, in which the data appears on the bus, i.e. at the input and output ports of the memory and to transfer the data to an external device for inspection. As the bus master or the CPU is not involved in this capturing process, the master or CPU resources are preserved for the normal operation of the microcontroller. As a consequence, the microcontroller shows the same behavior during application development, production and the final target application. The internal memory might be a volatile memory, like a random access memory (RAM), but other memory units may alternatively be used. The data can be transmitted without substantial decoding or similar modification steps. Accordingly, the memory trace module may be implemented with little complexity.

The memory trace module may include a data buffer, as for example a first in first out (FIFO) buffer, which is adapted to cache the captured data and/or address information arriving over the first interface, before the data is transmitted over the second interface. If the trace unit is adapted to trace a plurality of capture sources, as for example a plurality of memory blocks (e.g. RAM blocks), a plurality of First In First OUT (FIFO) may be provided and the memory trace module should preferably include means for implementing a round robin scheme for draining the FIFOs for the plurality of capture sources. A FIFO may be adapted to provide an overflow signaling means for signaling a FIFO overflow to an external device. A status bit may be used to indicate that an overflow occurs. Other signaling means for other purposes providing additional status bits may be implemented. Using FIFOs as intermediate buffers, between the first and the second interface, allows to organize and streamline the data traffic between the internal capturing process and the transfer to the external device via the second interface.

According to an aspect of the invention, the microcontroller may include a dedicated capture register and the memory trace module may be adapted to be switched between trace mode (as described above) and a direct data write mode. In direct data write mode, the data is directly written into the dedicated capture register (by the CPU or DMA) and transferred by the memory trace module to the external device via the second interface. The corresponding address information is to be determined only by the order of accesses by the central processing unit or direct memory access. This aspect of the invention allows for reading specific data and address information from a bus master, the CPU or other resources. In order to provide a quick access to the information to be traced, a specific dedicated register is implemented, which is only used for this purpose. Consequently, the additional information can be provided very effectively and without overhead. Further, the microcontroller may be adapted to provide a direct data read mode, wherein read data is directly written to the FIFO an transmitted via the second interface, without transmitting the address information.

According to another aspect of the invention, the information to be transmitted to the external device via the second interface is organized according to a dedicated trace mode protocol, including a specific packet format. The trace mode packet format provides packets including information as to capture source relating, for example, to the specific Random Access Memory (RAM) block dedicated to the data. Other individual packets may include information about the status of the FIFOS, the starting address and the size of the captured data. A specific packet for the captured data is also provided.

The packet format may be different for direct data mode (read and write), such that only data is transmitted in a single packet without additional address or status information. This allows for transmitting data more efficiently. Further aspects of the protocol will ensue from the description here below.

The second interface may provide one or more pins to receive signals from the external device. The received signal may indicate whether the external device is ready for data transmission. This aspect of the invention allows for establishing a basic communication protocol between the external device and the trace port module. Accordingly, data transmission may be suspended or interrupted as long as the external device signals a predetermined state (as e.g. external device is not ready to receive data) via the dedicated pins of the second interface.

Further, the second interface of the memory trace module may preferably be implemented as a serial interface to perform serial transmission by one or more pins. Providing a serial interface is helpful to keep the external pin count of the microcontroller small. However, the serial interface may have either two, four, eight or sixteen pins to provide flexibility for different applications and different amounts of data to be transmitted. The plurality of pins may provide a plurality of parallel transmission lines, each of which transmits data serially.

The memory trace module of the microcontroller may be adapted to be generally configurable via the CPU or a dedicated JTAG scan chain in order to allow non-intrusive control from external debug hardware.

In one embodiment, the memory trace module is coupled to a bus being coupled to an interface to a peripheral device for capturing data relating to the peripheral device. The memory trace module captures the data on the bus, transfers the data from the first interface to the second interface and from the second interface to an external device. Accordingly, the memory trace module is capable of capturing data from a memory, but also from bus structures connecting the CPU to interfaces for peripheral devices. The captured data may be transmitted over the second interface in compliance with a specific dedicated data protocol.

For trace mode operations of peripheral devices, the protocol is adapted. For many applications, a specific packet (or flags) indicating regions of the capture sources is provided, in particular for tracing of peripheral devices. Often, the address range for peripheral devices exceeds the address range for the memory blocks. Accordingly, the packet carrying the effective address is reduced, such that the saved bits can be used to indicate a specific region. The packet used to identify the memory blocks may also be used to indicate generally that peripheral tracing is carried out. The region packet (or flag) indicates one of at least two peripheral address ranges. Accordingly, the region packet may be used to reduce the amount of data, such that only specific sections of the peripheral address range are traced. A region flag allows to exclude address regions, which are of minor interest. The actual start address, or the address range within the entire peripheral address range, may be stored in an additional register to which the region flag refers.

The trace port module may also be coupled to an additional bus structure for receiving setting information for the trace port module. Accordingly, the setting of the trace port module may be carried out via peripheral devices via the peripheral interfaces.

The present invention relates also to a method for tracing data and corresponding address information being read from or written to an internal memory of a microcontroller, the method including the steps of capturing the data and corresponding address information from a bus being coupled to the input or output ports of the memory, storing the captured data and address information, for example, in a FIFO, transferring the data to an external device via an external interface.

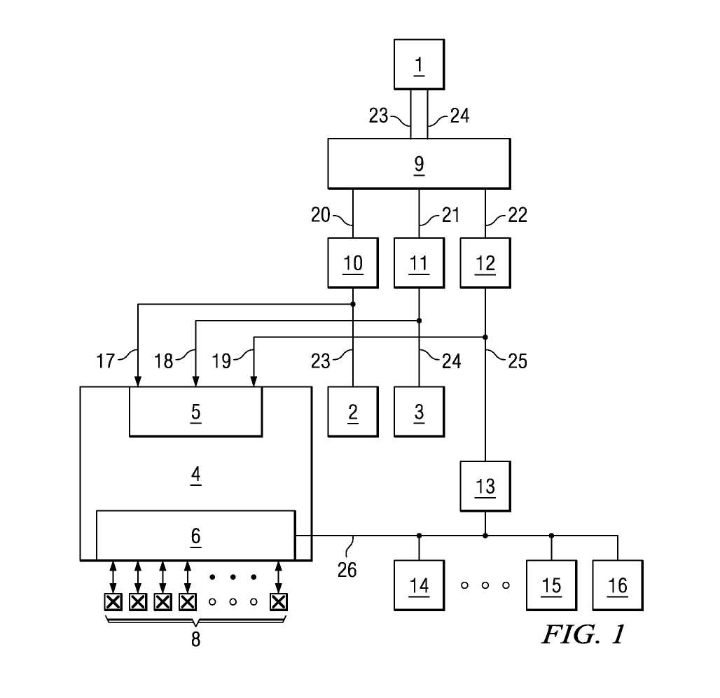

FIG. 1 shows a simplified basic structure of a microcontroller according to an embodiment of the invention. A CPU 1, a first memory block 2 and a second memory block 3 are implemented in the integrated electronic device. Although only two memory blocks 2, 3 are shown, the number of memory blocks 2, 3 is basically not limited. The CPU 1 is coupled to memory blocks 2 and 3 via bus structures and a bus matrix module 9, as well as, wrapper units 10, 11. The bus matrix module 9, and the wrapper units 10, 11 perform any necessary converting or decoding steps in order to transfer data correctly between the memory blocks 2, 3 and the CPU 1. Bus structures 17 and 18 are coupled to the bus portions 23 and 24 connecting the memory units 2, 3 to the CPU 1. The memory trace module 4 captures data and address information via the bus structure 17 and 18, as the data and the address information appear at the input and output ports of the memory blocks 2, 3. The memory blocks 2, 3 may be random access memories (RAM), but different memory types may also be used. The memory trace module 4 may include a first in first out (FIFO) buffer portion 5 for buffering the incoming data and the corresponding address information.

The memory trace module 4 includes a first internal interface for coupling the module 4 to bus portions 17, 18 and 19. The first internal interface is further coupled to FIFO 5 where incoming data is stored. The second external interface 6 may include a group of pins 8 that may be coupled to an external device (not shown). The external interface 6 is basically adapted to transmit the data and address information received via bus portions 17 and 18, the internal interface and FIFO 5 to an external device by use of a specific protocol. The number of pins of the group of external pins 8 depends on the specific implementation of the microcontroller and the application for which the microcontroller is to be used. Further bus structures 22, 25 and 26 are provided for connecting interfaces 14, 15 and 16 for peripheral devices to the CPU 1. Additional protocol translating units 12 and 13 may be implemented in order to establish communication between the CPU 1 and the interfaces 14, 15 and 16. The interfaces 14, 15 and 16 may be coupled via bus portions 26 to the interface 6 of the memory trace module 4. Accordingly, setting information propagating over bus portion 26 may be used to configure the memory trace module 4. The architecture shown in FIG. 1 is not only useful to trace data traffic between the CPU 1 and the memory blocks 2, 3, but also any other data transmitted to or from the memory blocks 2, 3 from or to a bus master can be traced.

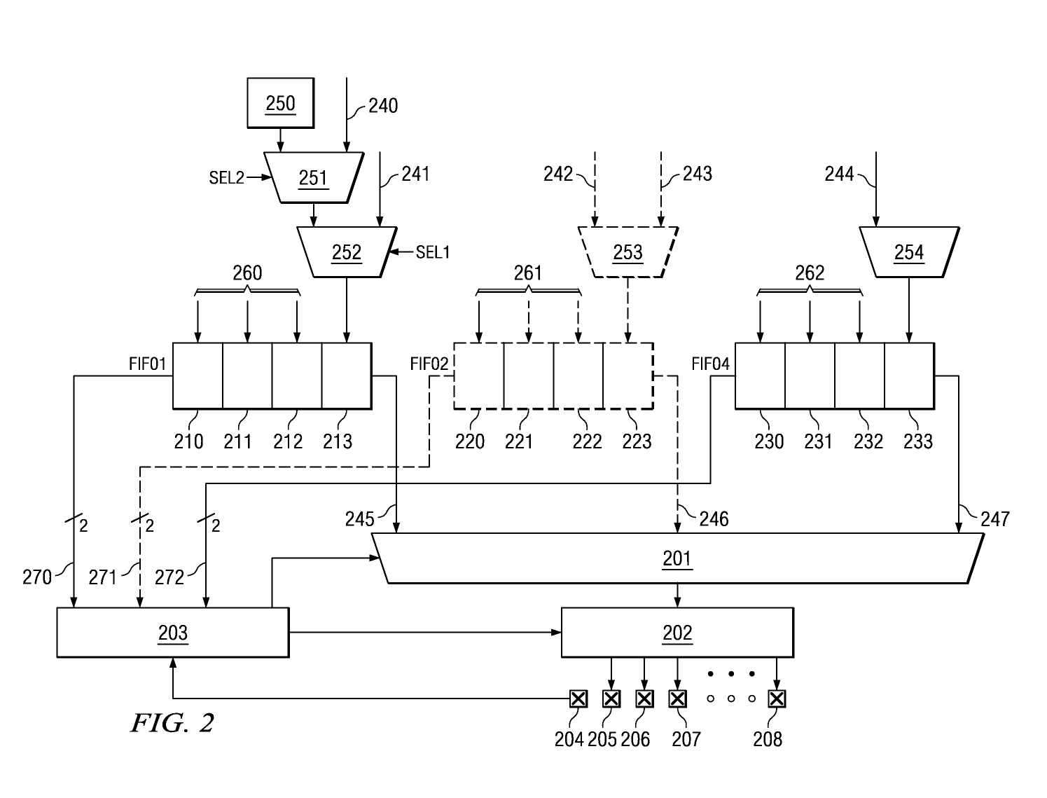

FIG. 2 shows a simplified block diagram of a memory trace module according to an embodiment of the present invention. In FIG. 2, the internal blocks of the memory trace module 4 are depicted in more detail than in FIG. 1. FIG. 2 shows three FIFOs, FIFO1, FIFO2 and FIFO4 and the respective logical components and bus connections for each of the FIFOs. The memory trace module provides two general modes: a trace mode and a direct data mode. In trace mode, the write data of the traced memory blocks are received via bus portions 240. So, bus 240 relates to write data and bus 241 conveys read data in direct data mode, which will be explained here below. The bus may have a bus width of 64 bit.

Direct data mode is subdivided in write and read mode. In direct data write mode, only the data written to a dedicated register, referred to as direct data mode register 250, is transmitted. In direct data read mode, data read from the memory (e.g. RAM) is directly written to the FIFOs. Multiplexers 251 and 252 and selection signals SEL1, SEL2 are provided in order to select the appropriate source for the data to be passed to FIFO1. FIFO1 receives also control signals, which are not shown. Basically, the same structures are shown for FIFO2 and FIFO4, where further selection signals are omitted for simplicity. The respective data to be captured arrives over bus portions 242, 243 and multiplexer 253 to FIFO2 or bus portion 244 and multiplexer 254 to FIFO4. Bus 244 is adapted to carry either write or read data.

In direct data mode (read and write), the actual data may be the only data transmitted. The address of the written data can only be determined by the order of writes or reads of the CPU 1 or DMA. The transfer size (as for example 8, 16 or 32 bit) may be programmable. Data which is not written or read in the correct transfer size will be truncated or extended. If, for example, the transfer sizes programmed to a 16 bit and a 32 bit write operation is required, the data written to the FIFO will be 32 bit wide, however, only the lower 16 bits of the FIFO will be transmitted. If an 8 bit operation is required, bits 8 to 15 of the FIFO will be indeterminate; thus, the upper 8 bits of the data transmitted are depending on the previous content of the FIFO.

In direct data mode write operation, the programming of the regions of all FIFOs will be discarded and no tracing of data is carried out. Only writes to register 250 are valid. In direct data mode read configuration, the read data will be captured directly in the FIFOs, however, no header and address information will be transmitted. As a result, the read order has to determine the correct address. The CPU 1 may use all FIFOs, FIFO1, FIFO2, and FIFO4 to capture data. In one embodiment, the CPU 1 ensures that one FIFO is completely empty before the next FIFO (e.g. FIFO2, which relates to a different memory unit, i.e. a different RAM block) will be filled. This is especially true when the data packet to be transmitted to the external device does not include information about the memory block (RAM block). The module shown in FIG. 2 may be configurable to different device configurations. The dashed elements in FIG. 2 show the optional parts depending on the configuration. The mapping of the FIFOs to the different resources depends on the device configuration. One of the FIFOs may be selected to belong only to peripheral devices, as for example, FIFO4. The module may be configurable via the CPU 1 or a specific JTAG port. Such configuration may be at device design time and, thus, may not be changed when such module is implemented. Such configuration, via CPU1 1 or JTAG, may relate to the programming of resources and/or registers of the module.

In one embodiment, in trace mode, a peripheral bus of the integrated electronic device can be traced. Whenever a write or read access occurs, the address data size (8, 16, 32, 64 bit) and a reference to the module that initiated the write or read operation, is captured into the FIFO of the corresponding memory block.

FIFO1, FIFO2 and FIFO4 are divided into sub-sections to store information relating to captured data. For FIFO1, there is a section relating to the master of the data transfer 210, a section for the size (amount of data) of the data transfer 211, a section for the starting address of the data 212 and the captured data 213. Respective sections 220, 221, 222, and 223, as well as 230, 231, 232, and 233 are provided for FIFO2 and FIFO4. The specific information and data relating to the master, block size and address of the traced data are received over additional respective groups of bus structures 260, 261 and 262. According to one embodiment, the FIFOs are 86 or 54 bit wide. The 86 or 54 bits are divided in the above mentioned sub-sections. The depth of the FIFO is 32 or 64 words corresponding to either 86 bits or 54 bits, respectively. In trace mode, two bits store the initiator (block 210), two bits store the size of the write operation (block 211), 64 bits store the data which was written (block 213) and 18 bits store the address (block 212) to which the data was written.

Further, a control unit 203 is coupled to FIFO1, FIFO2 and FIFO3 by bus structures 270, 271 and 272. The bus portions 270, 271 and 272 indicate whether the FIFOs are empty or whether there is an overflow of any of the FIFOs. The traced data and address information is passed via bus portions 245, 246 or 247, respectively to a multiplexer 201, which is controlled by controller 203 to select one of the three FIFOs, FIFO1, FIFO2, and FIFO4. The selected FIFO is switched through to serializer 202 to transform the captured data and corresponding information into serial data. From serializer 202, the captured data and corresponding information is passed to the external interface pins 204, 205, 206, 207 and 208. The external interface may be configured as serial interface.

Pins 207 and 208 of the external interface may represent a group of pins, rather than only two individual pins. These pins might be of any useful and advantageous number, for example, 2, 4, 8 or 16 pins for data transmission. Pin 206 may provide a clock signal and pin 205 may be used to provide a synchronization for external synchronization. Pin 204 may be configured to receive an enable signal from an external device in order to pause data transmission, if the external device is not ready to receive data.

In one aspect, if no data is stored in the FIFO, the FIFO may signal such state to the control block 203 via bus portion 270, 271, 272. Any data stored in the FIFO is to be transferred to the serializer 202, if the control block selects the particular FIFO. In one embodiment, if the FIFO is not emptied fast enough to prevent a FIFO overflow, an overflow signal will be asserted if the last location in the FIFO is occupied. The user may select whether the program execution or data transfer should be suspended in this case or whether an overflow is signaled in the status bits of the next message of this particular FIFO. The overflow may not be signaled in the message which is currently transmitted.

Multiplexer 201 may be adapted to be controlled according to a round robin scheme for transferring the data out of the different FIFOs into the serializer 202. As such, when in trace mode and when configured for three memory blocks (three RAMs), one packet from FIFO1 might be transferred, next one packet from the FIFO2 may be transferred, and then one packet from FIFO3. If a FIFO is empty, the control block skips the FIFO.

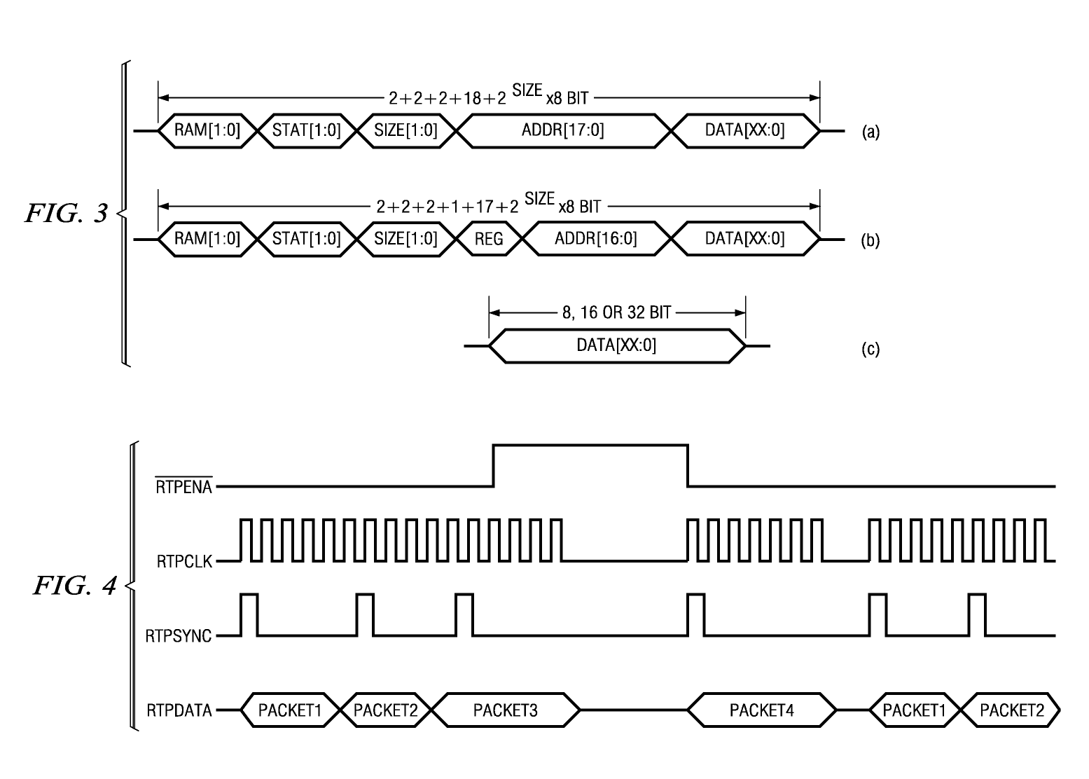

FIG. 3 shows different packet structures according to an aspect of the present invention. In this embodiment, FIG. 3 shows three different configurations of data protocols, i.e. packet formats for data transmission over the dedicated interface according to the present invention. FIG. 3(a) shows the packet format in trace mode for typical RAM locations. FIG. 3(b) shows a packet format for peripheral locations. FIG. 3(c) shows a packet format relating to direct data mode.

Referring to FIG. 3(a), when RAM locations are traced, one packet may consist of two bits RAM[1:0] denoting the RAM in which the data is stored, two status bits STAT[1:0], two bits for the size SIZE[1:0], and the 18 bit (256 KByte) address of the data ADDR[17:0] and 2̂SIZE×8 bits of data DATA[xx:0]. As shown in FIG. 3(b), the packets are slightly different if a peripheral location is captured. If a peripheral location is traced, then the effective address reduces to 17 bit (128 KByte) and the additional bit REG denotes the programmable region to be traced. With a region identifier REG, the external device can determine which peripheral was traced. The actual address or the address range for the peripheral tracing operation can be further defined in one or more internal registers. So, although the peripheral frame can span more than 256 KByte, the region number (in combination with an internal register used as an address pointer or the like) allows for tracing specific portions within even larger ranges. By the region flag REG, the external device can determine which peripheral was traced. For memory tracing and peripheral tracing SIZE[1:0] determines if there was a 8, 16, 32 or 64 bit write or read, which is necessary to reconstruct the 64 bit word on the external device. Generally, i.e. in FIG. 3(a) and (b), DATA[xx:0] is the data which was written. If there is a total of 3 memory blocks, each of which has a size of 256 KByte and one peripheral frame (128 KByte), it is necessary to transmit also from which frame the data arrives. This is done by RAM[1:0]. RAM[1:0] can include a specific state (e.g. ‘11’ if two bits are used) to indicate peripheral tracing. The address of the written data is transmitted by ADDR[17:0] or ADDR[16:0]. STAT[1:0] defines the status of the message or module and holds the initiator of the write or read operation. The flag REG of FIG. 3(b) defines the region of the peripheral frame to which the write or read was performed and is, therefore, helpful to reduce the data transmitted. As shown in FIG. 3(c) for direct data mode write or read operation, only the data written to the specific register 250 or the data read from the memory unit (e.g. a RAM block) is captured in the FIFO of the memory trace module 4 and transmitted as a single packet DATA[xx:0]. The packet length is programmable to, for example, 8, 16 or 32 bits.

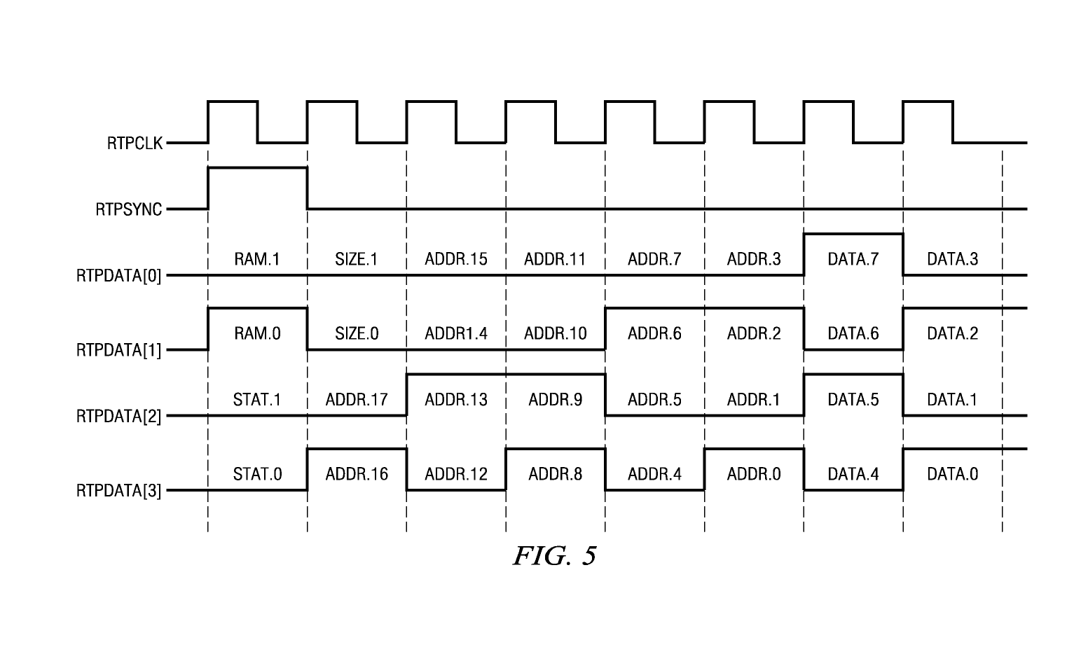

FIG. 4 shows signal waveforms and timing according to an aspect of the present invention. FIG. 4 shows waveform diagrams for signals as they may occur at pins 204, 205, 206, 207, and 208 (shown in FIG. 2) of the external interface according to an embodiment of the invention. The enable signal RTPENA is asserted by the external device. RTPENA is LOW in order to indicate whether the external device is ready to receive data from the memory trace module of the microcontroller. IF RTPENA is HIGH, data transmission is paused, but only after the transmission of the whole packet is finished. The external clock RTPCLK is asserted by the memory trace module during data transmission. The clock might be configured to be suspended or free running, if a packet data transmission is finished. The memory trace module provides a synchronization signal RTPSYNC. This signal is HIGH for one RTPCLK clock cycle in order to synchronize external hardware to the data stream (each packet). Data is transmitted over a single, two, four, eight or more pins as indicated by RTPDATA. The configuration using four pins will be explained with respect to FIG. 5.

FIG. 5 shows further signal waveforms according to an aspect of the present invention. FIG. 5 shows waveforms for a configuration, where four pins RTPDATA [1], RTPDATA [2], RTPDATA [3] und RTPDATA [4] are used for data transmission. The synchronization pin RTPSYNC is HIGH for only one clock cycle of clock signal RTPCLK. FIG. 5 relates to trace mode data transmission for an internal RAM block. Accordingly, the packet format as explained with respect to FIG. 3(a) is used. The respective bits of the packets are distributed systematically over the four pins. The first bit of RAM[1:0] is transmitted over RTPDATA[0] as RAM.1. The second bit, which is RAM.0 is transmitted via the next pin, RTPDATA[1]. The two status bits of STAT[1:0] are assigned to RTPDATA[2] and RTPDATA[3]. As all four pins are used, the next bit, which is SIZE.1, is assigned to RTPDATA[0]. This procedure is continued until all bits are transmitted.

In terms of integration on a semiconductor substrate, the components mentioned here above are considered to be basically all implemented on the same single semiconductor die. This relates to the CPU, the memory, which is preferably an internal RAM of the microcontroller, and the interfaces for the peripheral devices. For different applications, different microcontrollers may be designed and synthesized including different numbers and embodiments of the above described components.

What is claimed is:

1. A microcontroller comprising
a central processing unit;
a memory;
a bus coupling the memory to the central processing unit; and
a memory trace module for tracing at least one of a data of a write access to memory or data of a read access from the memory, wherein the memory trace module comprises:
a first interface being coupled to the bus for capturing at least one of the data or corresponding address information on the bus; and
a second interface coupled to an external device, wherein the memory trace module is adapted to transfer captured data from the first to the second interface and from the second interface to the external device.

2. The microcontroller of claim 1, wherein the captured data includes address information.

3. The microcontroller of claim 1, wherein the transfer of the captured data is done in at least one of trace data mode or direct data mode.

4. The microcontroller of claim 1, wherein the memory trace module further comprises a FIFO being adapted to cache the captured data and corresponding address information received via the first interface before transmitting the data via the second interface.

5. The microcontroller of claim 4, further comprising:
a plurality of FIFOs;
a plurality of memory blocks; and
a means for implementing a round robin scheme for draining the FIFOs for a plurality of sources.

6. The microcontroller of claims 4 further comprising overflow signaling means for signaling a FIFO overflow to the external device.

7. The microcontroller of claim 1 further comprising a dedicated capture register, wherein the memory trace module is adapted to be switched between a trace mode and a direct data mode, and wherein, in the direct data mode, the memory trace module is adapted to retrieve data to be captured directly from the dedicated capture register and to transfer the data to the external device.

8. The microcontroller of one of claim 1, wherein the second interface comprises a pin adapted to receive a signal indicating whether the external device is ready for data transmission.

9. The microcontroller of one of claim 1, wherein the second interface is adapted to perform serial data transmission.

10. The microcontroller of claim 9, wherein the second interface comprises either two (2), four (4), eight (8) or sixteen (16) pins for serial data transmission on a plurality of parallel transmission lines.

11. The microcontroller of claim 1, wherein the memory trace module is further coupled to a bus connecting the CPU to an interface for a peripheral device and adapted to capture data propagating on the bus between the CPU and the peripheral device, to transfer the captured data to the second interface and to transmit the captured data to the external device via the second interface.

12. A method for tracing at least one of data of a write access to a memory or data of a read access from the memory, the method comprising:
capturing at least one of a data of a write access to memory or data of a read access from the memory via a first interface coupled to the memory;
transferring the captured data from the first interface to a second interface, wherein the second interface is coupled to an external device;
transferring the captured data to the external device via the second interface; and
tracing the captured data from the memory to the external device.

13. The method of claim 12 further comprising logging information related to the tracing of captured data.

14. The method of claim 12, where in the method is a protocol providing a packet oriented data format comprising at least one of individual packets for the capture source, a status information of the capture source, a starting address of the captured data, the size of the captured data, or the captured data.
